(19) United States
(12) Patent Application Publication
(10) Pub. No.: US 2013/0214979 A1
(43) Pub. Date: Aug. 22, 2013

(54) Electronic Device Antennas with Filter and Tuning Circuitry

(71) Applicants: Emily B. McMilin, Mountain View, CA (US); Qingxiang Li, Mountain View, CA (US); Robert W. Schlub, Cupertino, CA (US)

(72) Inventors: Emily B. McMilin, Mountain View, CA (US); Qingxiang Li, Mountain View, CA (US); Robert W. Schlub, Cupertino, CA (US)

(21) Appl. No.: 13/399,800

(22) Filed: Feb. 17, 2012

(51) Int. Cl. H01Q 9/06

(52) U.S. Cl. 343/750; 343/749

(57) ABSTRACT

An electronic device may have an antenna that includes conductive antenna structures forming an antenna resonating element and an antenna ground. A band-stop filter may be coupled between first and second portions of the conductive structures. The band-stop filter may be formed from multiple series-connected resonant circuits. The band-stop filter and an impedance matching circuit may be coupled in series between the antenna resonating element and the antenna ground. The band-stop filter may be characterized by a stop band. The antenna may be configured to operate in a first communications band that is outside of the stop band and a second communications band that is covered by the stop band. The impedance matching circuit may be an adjustable circuit that is used to tune the antenna. The adjustable circuit may be a switch-based adjustable capacitor that is adjusted to tune the response of the antenna in the first communications band.

### BACKGROUND

This relates generally to electronic devices, and more particularly, to antennas for electronic devices.

Electronic devices such as portable computers and cellular telephones are often provided with wireless communications capabilities. For example, electronic devices may use long-range wireless communications circuitry such as cellular telephone circuitry to communicate using cellular telephone bands. Electronic devices may use short-range wireless communications circuitry such as wireless local area network communications circuitry to handle communications with nearby equipment. Electronic devices may also be provided with satellite navigation system receivers and other wireless circuitry.

To satisfy consumer demand for small form factor wireless devices, manufacturers are continually striving to implement wireless communications circuitry such as antenna components using compact structures. At the same time, it may be desirable to include conductive structures in an electronic device such as metal device housing components. Because conductive components can affect radio-frequency performance, care must be taken when incorporating antennas into an electronic device that includes conductive structures. For example, care must be taken to ensure that the antennas and wireless circuitry in a device are able to exhibit satisfactory performance over a range of operating frequencies without causing undesired interference.

It would therefore be desirable to be able to provide wireless electronic devices with improved antenna structures.

### SUMMARY

An electronic device may have an antenna. The antenna may include conductive structures forming an antenna resonating element and an antenna ground. The antenna ground may be formed from electronic device housing structures. The antenna resonating element may be an inverted-F antenna resonating element or other suitable antenna resonating element.

A band-stop filter may be coupled between first and second portions of the conductive structures. For example, the band-stop filter may be coupled between the antenna resonating element and the antenna ground.

The antenna resonating element may include an antenna resonating element arm. An antenna feed branch may be coupled between the antenna resonating element arm and the antenna ground. At a different location on the antenna resonating element arm, the band-stop filter and an impedance matching circuit may be coupled in series between the antenna resonating element arm and the antenna ground.

The band-stop filter may be formed from multiple stages connected in series. Each stage of the band-stop filter may include a resonant circuit formed from a capacitor and inductor coupled in parallel. The resonance peak of each stage may be different to extend the bandwidth of the band-stop filter.

The band-stop filter may be characterized by a stop band. The antenna may be configured to operate in a first communications band that is outside of the stop band and a second communications band that is covered by the stop band. The impedance matching circuit may be an adjustable circuit that is used to tune the antenna. The adjustable circuit may be a switch-based adjustable capacitor that is adjusted to tune the response of the antenna in the first communications band.

Further features of the invention, its nature and various advantages will be more apparent from the accompanying drawings and the following detailed description of the preferred embodiments.

### BRIEF DESCRIPTION OF THE DRAWINGS

FIG. 1 is a perspective view of an illustrative electronic device with wireless communications circuitry in accordance with an embodiment of the present invention.

FIG. 2 is a schematic diagram of an illustrative electronic device with wireless communications circuitry in accordance with an embodiment of the present invention.

FIG. 3 is a diagram of an illustrative antenna with filter and matching circuitry that may be used in wireless electronic devices of the type shown in FIGS. 1 and 2 in accordance with an embodiment of the present invention.

FIG. 4 is a diagram of an inverted-F antenna without a short circuit branch in accordance with an embodiment of the present invention.

FIG. 5 is an antenna performance graph showing how the antenna of FIG. 4 may have a resonance peak that covers a communications band of interest in accordance with an embodiment of the present invention.

FIG. 6 is a diagram of an inverted-F antenna with a short circuit branch in accordance with an embodiment of the present invention.

FIG. 7 is an antenna performance graph showing how the antenna of FIG. 6 may have a resonance peak that covers a communications band of interest at a lower frequency than the communications band covered with the antenna structures of FIG. 4 in accordance with an embodiment of the present invention.

FIG. 8 is a circuit diagram of an illustrative band-stop filter of the type that may be used in an antenna such as the antenna of FIG. 3 in accordance with an embodiment of the present invention.

FIG. 9 is graph of impedance versus frequency for the band-stop filter of FIG. 8 in accordance with an embodiment of the present invention.

FIG. 10 is a graph of transmission versus frequency for an illustrative band-stop filter of the type shown in FIG. 8 in accordance with an embodiment of the present invention.

FIG. 11 is a circuit diagram of an illustrative adjustable impedance matching circuit of the type that may be used in tuning an antenna such as the antenna of FIG. 3 in accordance with an embodiment of the present invention.

FIG. 12 is an antenna performance graph showing how the antenna of FIG. 3 may have low band and high band resonances and showing how the low band response may be tuned using an adjustable matching circuit of the type shown in FIG. 11 in accordance with an embodiment of the present invention.

### DETAILED DESCRIPTION

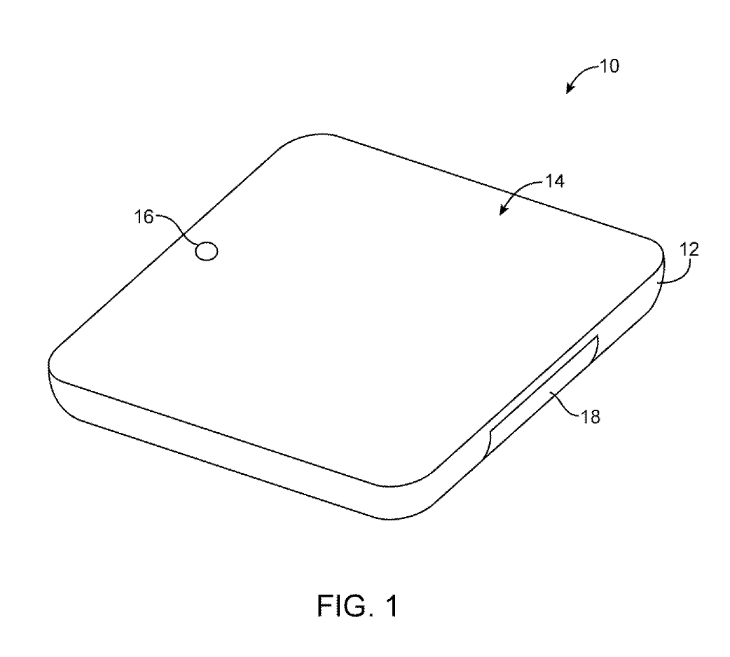

Electronic devices such as electronic device 10 of FIG. 1 may be provided with wireless communications circuitry. The wireless communications circuitry may be used to support wireless communications in multiple wireless communications bands. The wireless communications circuitry may include one or more antennas.

The antennas can include loop antennas, inverted-F antennas, strip antennas, planar inverted-F antennas, slot antennas, hybrid antennas that include antenna structures of more than one type, or other suitable antennas. Conductive structures for the antennas may, if desired, be formed from conductive electronic device structures. The conductive electronic device structures may include conductive housing structures such as conductive housing wall structures. The housing structures may include a peripheral conductive member that runs around the periphery of an electronic device. The peripheral conductive member may serve as a bezel for a planar structure such as a display, may serve as sidewall structures for a device housing, and/or may form other housing structures. Gaps in the peripheral conductive member may be associated with the antennas.

The antennas may, if desired, be formed from patterned metal foil or other metal structures or may be formed from conductive traces such as metal traces on a substrate. The substrate may be a plastic structure or other dielectric structure, a rigid printed circuit board substrate such as a fiberglass-filled epoxy substrate (e.g., FR4), a flexible printed circuit (“flex circuit”) formed from a sheet of polyimide or other flexible polymer, or other substrate material. The housing for electronic device 10 may be formed from conductive structures (e.g., metal) or may be formed from dielectric structures (e.g., glass, plastic, ceramic, etc.). Antenna windows formed from plastic or other dielectric material may, if desired, be formed in conductive housing structures. Antennas for device 10 may be mounted so that the antenna window structures overlap the antennas. During operation, radio-frequency antenna signals may pass through the dielectric antenna windows and other dielectric structures in device 10.

Electronic device 10 may be a portable electronic device or other suitable electronic device. For example, electronic device 10 may be a laptop computer, a tablet computer, a somewhat smaller device such as a wrist-watch device, pendant device, headphone device, earpiece device, or other wearable or miniature device, a cellular telephone, or a media player. Device 10 may also be a television, a set-top box, a desktop computer, a computer monitor into which a computer has been integrated, or other suitable electronic equipment.

Device 10 may have a display such as display 14 that is mounted in a housing such as housing 12. Display 14 may be a touch screen that incorporates capacitive touch electrodes or may be insensitive to touch. Display 14 may include image pixels formed from light-emitting diodes (LEDs), organic LEDs (OLEDs), plasma cells, electrowetting pixels, electrophoretic pixels, liquid crystal display (LCD) components, or other suitable image pixel structures. A cover glass layer may cover the surface of display 14. The cover glass may have one or more openings such as an opening to accommodate button 16.

Housing 12, which may sometimes be referred to as a case, may be formed of plastic, glass, ceramics, fiber composites, metal (e.g., stainless steel, aluminum, etc.), other suitable materials, or a combination of these materials. In some situations, housing or parts of housing 12 may be formed from dielectric or other low-conductivity material. In other situations, housing 12 or at least some of the structures that make up housing 12 may be formed from metal elements. In configurations for device 10 in which housing 12 is formed from conductive materials such as metal, one or more dielectric antenna windows such as antenna window 18 of FIG. 1 may be formed in housing 12.

Antenna window 18 may be formed from a dielectric such as plastic (as an example). Antennas in device 10 may be mounted within housing 12 so that antenna window 18 overlaps the antennas. During operation, radio-frequency antenna signals can pass through antenna window 18 and other dielectric structures in device 10 (e.g., edge portions of the cover glass for display 14).

Antennas in device 10 may be used to support any communications bands of interest. For example, device 10 may include antenna structures for supporting local area network communications, voice and data cellular telephone communications, global positioning system (GPS) communications or other satellite navigation system communications, Bluetooth® communications, etc.

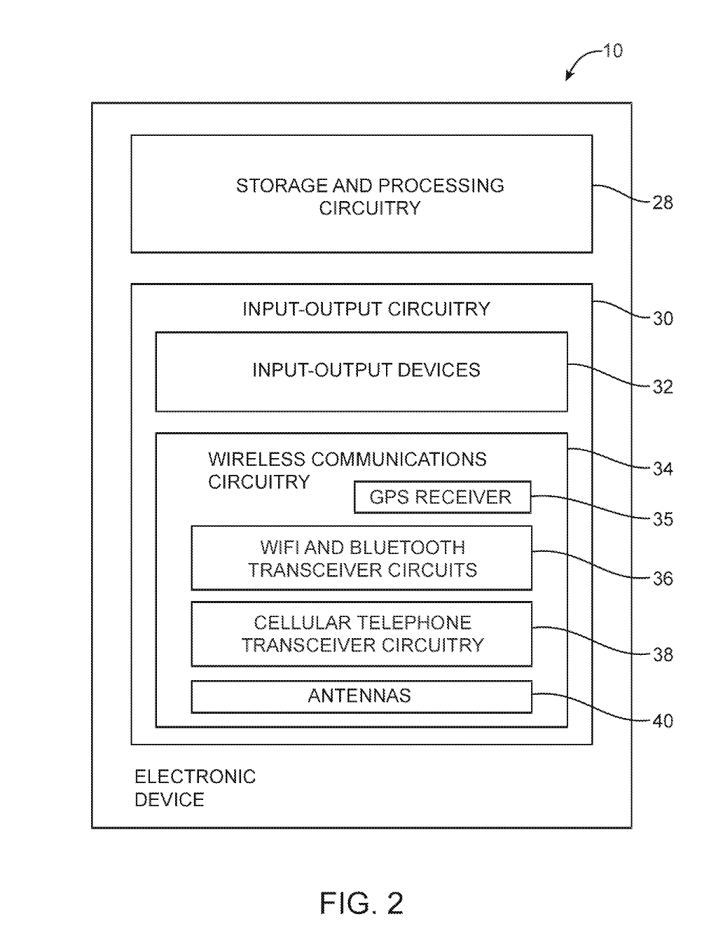

A schematic diagram of an illustrative configuration that may be used for electronic device 10 is shown in FIG. 2. As shown in FIG. 2, electronic device 10 may include control circuitry such as storage and processing circuitry 28. Storage and processing circuitry 28 may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in storage and processing circuitry 28 may be used to control the operation of device 10. The processing circuitry may be based on one or more microprocessors, microcontrollers, digital signal processors, baseband processors, power management units, audio codec chips, application specific integrated circuits, etc.

Storage and processing circuitry 28 may be used to run software on device 10, such as internet browsing applications, voice-over-internet-protocol (VOIP) telephone call applications, email applications, media playback applications, operating system functions, etc. To support interactions with external equipment, storage and processing circuitry 28 may be used in implementing communications protocols. Communications protocols that may be implemented using storage and processing circuitry 28 include internet protocols, wireless local area network protocols (e.g., IEEE 802.11 protocols—sometimes referred to as WiFi®), protocols for other short-range wireless communications links such as the Bluetooth® protocol, cellular telephone protocols, etc.

Circuitry 28 may be configured to implement control algorithms that control the use of antennas in device 10. For example, circuitry 28 may perform signal quality monitoring operations, sensor monitoring operations, and other data gathering operations and may, in response to the gathered data and information on which communications bands are to be used in device 10, control which antenna structures within device 10 are being used to receive and process data and/or may adjust one or more switches, tunable elements, or other adjustable circuits in device 10 to adjust antenna performance. As an example, circuitry 28 may control which of two or more antennas is being used to receive incoming radio-frequency signals, may control which of two or more antennas is being used to transmit radio-frequency signals, may control the process of routing incoming data streams over two or more antennas in device 10 in parallel, may tune an antenna to cover a desired communications band, etc. In performing these control operations, circuitry 28 may open and close switches, may turn on and off receivers and transmitters, may adjust impedance matching circuits, may configure switches in front-end-module (FEM) radio-frequency circuits that are interposed between radio-frequency transceiver circuitry and antenna structures (e.g., filtering and switching circuits used for impedance matching and signal routing), may adjust switches, tunable circuits, and other adjustable circuit elements that are formed as part of an antenna or that are coupled to an antenna or a signal path associated with an antenna, and may otherwise control and adjust the components of device 10.

Input-output circuitry 30 may be used to allow data to be supplied to device 10 and to allow data to be provided from device 10 to external devices. Input-output circuitry 30 may include input-output devices 32. Input-output devices 32 may include touch screens, buttons, joysticks, click wheels, scrolling wheels, touch pads, key pads, keyboards, microphones, speakers, tone generators, vibrators, cameras, sensors, light-emitting diodes and other status indicators, data ports, etc. A user can control the operation of device 10 by supplying commands through input-output devices 32 and may receive status information and other output from device 10 using the output resources of input-output devices 32.

Wireless communications circuitry 34 may include radio-frequency (RF) transceiver circuitry formed from one or more integrated circuits, power amplifier circuitry, low-noise input amplifiers, passive RF components, one or more antennas, and other circuitry for handling RF wireless signals. Wireless signals can also be sent using light (e.g., using infrared communications).

Wireless communications circuitry 34 may include satellite navigation system receiver circuitry such as Global Positioning System (GPS) receiver circuitry 35 (e.g., for receiving satellite positioning signals at 1575 MHz) or satellite navigation system receiver circuitry associated with other satellite navigation systems. Transceiver circuitry 36 may handle 2.4 GHz and 5 GHz bands for WiFi® (IEEE 802.11) communications and may handle the 2.4 GHz Bluetooth® communications band. Circuitry 34 may use cellular telephone transceiver circuitry 38 for handling wireless communications in cellular telephone bands such as bands in frequency ranges of about 700 MHz to about 2200 MHz or bands at higher or lower frequencies. Wireless communications circuitry 34 can include circuitry for other short-range and long-range wireless links if desired. For example, wireless communications circuitry 34 may include wireless circuitry for receiving radio and television signals, paging circuits, etc. In WiFi® and Bluetooth® links and other short-range wireless links, wireless signals are typically used to convey data over tens or hundreds of feet. In cellular telephone links and other long-range links, wireless signals are typically used to convey data over thousands of feet or miles.

Wireless communications circuitry 34 may include antennas 40. Antennas 40 may be formed using any suitable types of antenna. For example, antennas 40 may include antennas with resonating elements that are formed from loop antenna structure, patch antenna structures, inverted-F antenna structures, closed and open slot antenna structures, planar inverted-F antenna structures, helical antenna structures, strip antennas, monopoles, dipoles, hybrids of these designs, etc. Different types of antennas may be used for different bands and combinations of bands. For example, one type of antenna may be used in forming a local wireless link antenna and another type of antenna may be used in forming a remote wireless link.

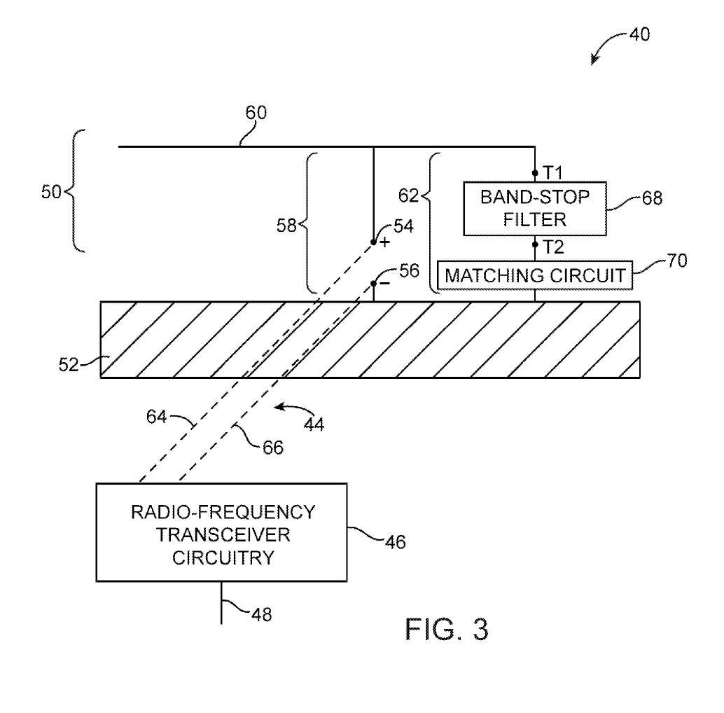

There is generally a tradeoff between antenna volume and antenna bandwidth. An antenna that is implemented in a constrained volume, as is sometimes necessary to satisfy a desire for device compactness, will tend to exhibit a smaller bandwidth than a comparable antenna that is implemented in a larger volume. An illustrative antenna of the type that may be used in device 10 is shown in FIG. 3. Antenna 40 may be implemented in a relatively constrained volume (if desired). To ensure that antenna 40 of FIG. 3 exhibits a desired frequency response, antenna 40 may be provided with features such as filter circuit 68 and/or matching circuit 70.

Filter circuit 68 may be a band-stop filter or other filter circuit that exhibits different impedances at different operating frequencies. This allows filter circuit 68 to form a closed or open circuit as a function of frequency. The behavior of filter circuitry 68 electrically connects and disconnects portions of antenna 40 from each other during operation of device 10 to place antenna 40 into configurations suitable for exhibiting desired frequency responses.

Matching circuit 70 may be formed from fixed components that help antenna 40 achieve a desired frequency response or may be formed from an adjustable circuit. The adjustable circuit may, as an example, be adjusted in real time so that circuit 70 exhibits different impedances in different modes of operation. The different impedances exhibited by matching circuit 70 may be used in tuning antenna 40 to cover desired frequencies of interest.

As shown in FIG. 3, antenna 40 may include conductive antenna structures that form antenna resonating element 50 and antenna ground 52. Antenna resonating element 50 may, for example, be formed from patterned metal traces on a rigid or flexible printed circuit substrate or patterned metal traces on a molded plastic substrate (as examples). Antenna ground 52 may be formed from metal traces on a printed circuit, metal traces on a molded plastic substrate, and/or other conductive structures such as metal portions of housing 12. Antenna resonating element 50 in the example of FIG. 3 is an inverted-F antenna resonating element. This is merely illustrative. Antennas in device 10 may be based on any suitable type of antenna (e.g., a loop antenna, a strip antenna, a planar inverted-F antenna, a slot antenna, a hybrid antenna that includes antenna structures of more than one type, or other suitable antennas).

Antenna resonating element 50 may include a main resonating element arm such as arm 60. Arm 60 may have a straight shape, a curved shape, a shape with one or more bends, a shape with one or more branches, or other suitable shapes. Short circuit branch 62 may be coupled between antenna resonating element arm 60 and antenna ground 52. Filter 68 and matching circuit 70 may be coupled in series between antenna resonating element arm 60 and ground 52. Antenna 40 may have an antenna feed formed from feed terminals 54 and 56 in antenna feed branch 58. Antenna feed branch 58 may be coupled between arm 60 and ground 52.

Signal path 44 may be coupled to the antenna feed in antenna 40. Signal path 44 may include positive path 64 and ground path 66. Positive path 64 may be coupled to positive antenna feed terminal 54. Ground signal path 66 may be coupled to ground antenna feed terminal 56. Signal path 44 may include transmission line structures. For example, signal path 44 may include one or more portions of a coaxial cable transmission line, one or more microstrip transmission lines, one or more stripline transmission lines, or other transmission line structures. Impedance matching circuits, filters, switches, and other circuitry may, if desired, be interposed in path 44.

Antenna resonating element 50 in the example of FIG. 3 is an inverted-F antenna resonating element. This is merely illustrative. Antenna 40 may be based on any suitable type of antenna (e.g., a loop antenna, a strip antenna, a planar inverted-F antenna, a slot antenna, a hybrid antenna that includes antenna structures of more than one type, or other suitable antennas).

Filter circuitry such as band-stop filter 68 and impedance matching circuitry 70 may be coupled between arm 60 and ground 52 as shown in FIG. 3 or may be coupled between other conductive structures in antenna 40.

For example, filter 68 may have a first terminal T1 that is coupled to antenna resonating element arm 60 and a second terminal T2 that is coupled to antenna ground 52 via matching circuit 70, as shown in FIG. 3. If desired, filter 68 may be coupled between different portions of arm 60 or other portions of antenna resonating element 50 (i.e., terminal T1 may be connected to a first location in element 50 and terminal T2 may be coupled to a different location in element 50), filter 68 may be coupled between arm 60 and ground 52 in a path that is separate from short circuit branch 62, terminals T1 and T2 may be coupled to different respective portions of ground 52, etc. Matching circuit 70 may, if desired, have first and second terminals that are coupled to respective locations in antenna resonating element 50, first and second terminals that are coupled to respective locations in antenna ground 52, terminals that connect different portions of resonating element 50 to each other, terminals that couple antenna resonating element 50 to antenna ground 52 in a path that is separate from short circuit branch 62, etc. The configuration of FIG. 3 is merely illustrative.

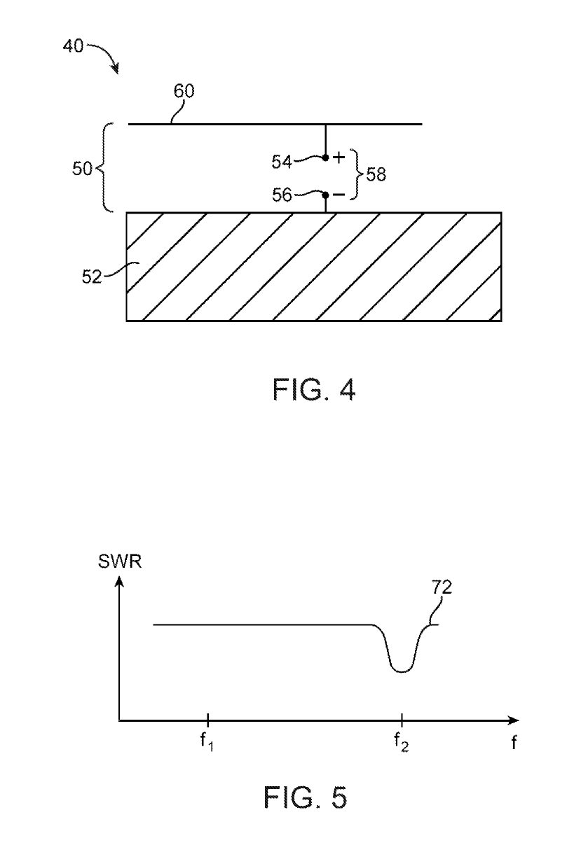

Band-stop filter 68 and impedance matching circuit 70 may be configured to help antenna 40 cover desired communications bands of interest. The operation of band-stop filter 68 and matching circuit 70 in antenna 40 of FIG. 3 can be understood with reference to FIGS. 4-12.

Consider, as an example, antenna 40 in a configuration of the type shown in FIG. 4. In this configuration, short circuit branch 62 has been removed from antenna resonating element 50. In FIG. 5, antenna performance (standing wave ratio) for the antenna configuration of FIG. 4 has been plotted as a function of frequency. As shown by curve 72, antenna 40 may exhibit a resonant peak at a frequency of f2 in the absence of short circuit branch 62 (as an example). The resonance centered at frequency f2 may be associated with a communications band of interest (e.g., cellular telephone communications frequencies, local area network communications frequencies of interest, etc.).

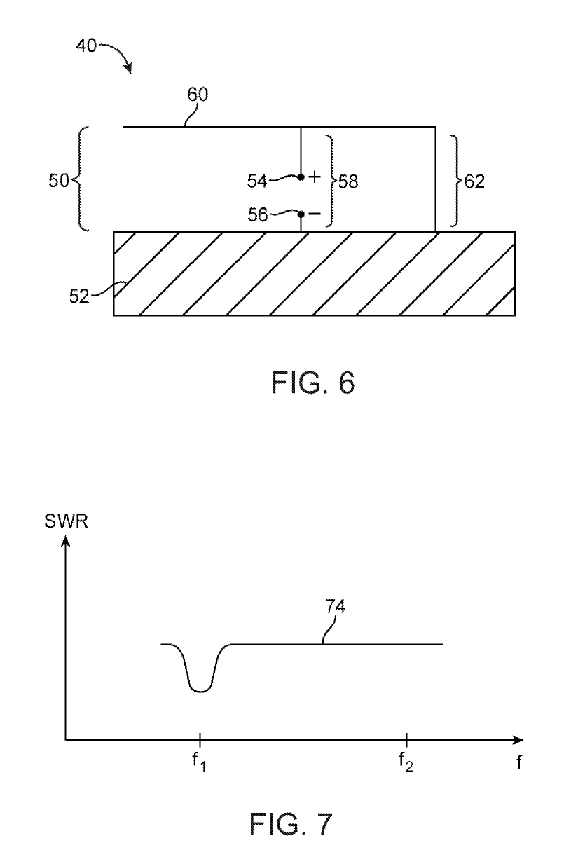

When short circuit branch 62 is added to antenna 40 of FIG. 4, antenna 40 may have a configuration of the type shown in FIG. 6. In FIG. 7, antenna performance (standing wave ratio) for the antenna configuration of FIG. 6 has been plotted as a function of frequency. As shown by curve 74, antenna 40 may exhibit a resonant peak at a frequency of f1 in the presence of short circuit branch 62. The resonance centered at frequency f1 may be associated with a communications band of interest (e.g., cellular telephone communications frequencies, local area network communications frequencies of interest, etc.).

By incorporating band-stop filter 68 into branch 62, as shown in FIG. 3, antenna 40 of FIG. 3 may exhibit resonances at both frequency f1 and frequency f2. The band-stop filter may be configured so that its stop band covers the resonance of curve 72 at frequency f2. At frequencies within the stop band, the impedance of filter 68 will be high and filter 68 will act as an open circuit (i.e., antenna 40 of FIG. 3 will act as if short circuit path 62 is absent, as described in connection with FIGS. 4 and 5). At frequencies outside of the stop band, such as frequencies in the communications band at frequency f1, the impedance of filter 68 will be low and filter 68 will act as a closed circuit (i.e., antenna 40 of FIG. 3 will act as if short circuit path 62 is present, as described in connection with FIGS. 6 and 7). Antenna 40 of FIG. 3 will therefore exhibit a low-band resonance such as the resonance at frequency f1 of curve 74 of FIG. 7 and will exhibit a high-band resonance such as the resonance at frequency f2 of curve 72 of FIG. 5. If desired, antenna 40 may be configured to exhibit additional resonances (e.g., at additional communications bands of interest).

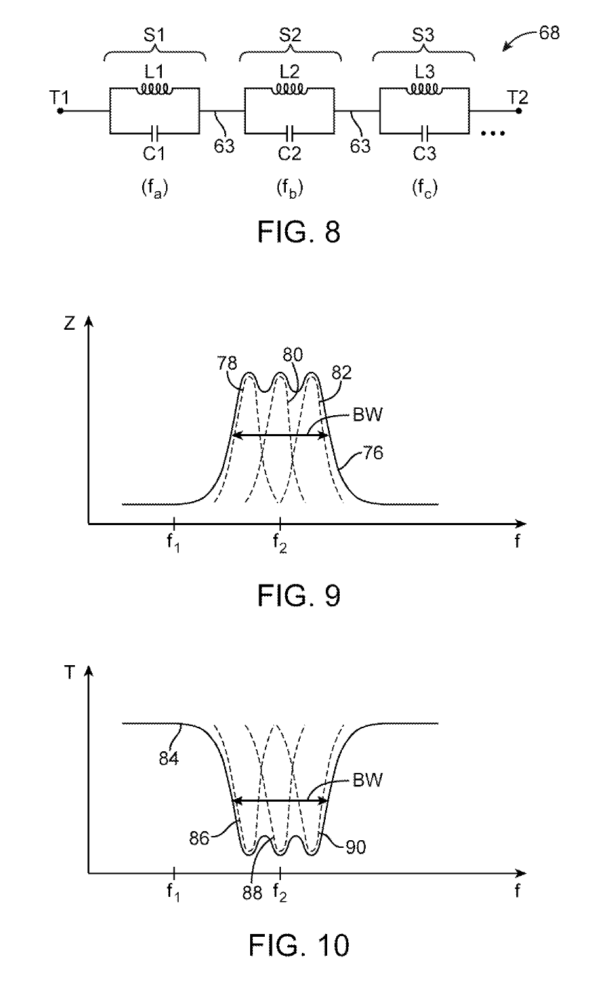

FIG. 8 is a circuit diagram of an illustrative configuration that may be used for band-stop filter 68. Band-stop filter 68 includes multiple stages (S1, S2, and S3). There are three stages in band-stop filter 68 of FIG. 8, but a different number of stages may be used in band-stop filter 68 if desired (e.g., band-stop filter 68 may have one or more stages, two or more stages, three or more stages, four or more stages, five or more stages, one to three stages, two to five stages, three to ten stages, fewer than five stages, or other suitable number of stages).

Band-stop filter 68 may have a first terminal such as terminal T1 and a second terminal such as terminal T2. Band-stop filter stages S1, S2, and S3 may be coupled in series between terminals T1 and T2. Terminal T1 may be coupled to antenna resonating element arm 60 of antenna resonating element 50, as shown in FIG. 3. Terminal T2 may be coupled to antenna ground 52 via optional matching circuit 70.

Band-stop filter 68 need not include ground terminals (i.e., conductive lines 63 may be floating and need not be shorted to ground). Each stage of filter 68 may have circuit components that form a respective resonant circuit. The resonant circuits may be formed from a network of electrical components such as inductors, capacitors, and resistors). In the illustrative configuration shown in FIG. 8, each stage includes an inductor and a capacitor coupled in parallel between the two respective terminals of the stage. For example, stage S1 includes inductor L1 coupled in parallel with capacitor C1, stage S2 includes inductor L2 coupled in parallel with capacitor C2, and stage S3 includes inductor L3 coupled in parallel with capacitor C3.

The magnitude of inductances L1, L2, and L3 and capacitances C1, C2, and C3 may be configured so that each stage exhibits a resonance at a different corresponding resonant frequency (i.e., at a different corresponding resonance peak). The resonant frequencies (resonance peaks) can be chosen so that the resonances associated the stages overlap and create a stop band of a desired width.

FIG. 9 is a graph in which the magnitude of the impedance Z of band-stop filter 68 (curve 76) has been plotted as a function of frequency f. The individual response of each filter stage in filter 68 is associated with a respective one of curves 78, 80, and 82. In particular, the impedance of filter stage S1 is represented by curve 78, the impedance of filter stage S2 is represented by curve 80, and the impedance of filter stage S3 is represented by curve 82. Each of these impedances contributes to the overall response of filter 68 (i.e., the set of all three series-connected resonant circuits), which is given by impedance curve 76 and covers a bandwidth BW. In this example, filter 68 contains three stages, so there are three corresponding impedance contributions to curve 76. In configurations for band-stop filter 68 with fewer individual resonant filter stages or with more individual resonant filter stages, the number of individual impedance curves that contribute to overall impedance curve 76 will vary accordingly.

As curve 76 of FIG. 9 demonstrates, the impedance exhibited by band-stop filter 68 will be high in the stop band centered at frequency f2 (i.e., filter 68 will effectively form an open circuit between terminals T1 and T2 at frequencies in the high band because the stop band of filter 68 covers the high communications band) and will be low at other frequencies (i.e., filter 68 will effectively form a short circuit at frequencies outside of the stop band such as frequencies surrounding frequency f1).

The resulting radio-signal transmission T of filter 68 as a function of frequency f when operated in antenna 40 is shown in FIG. 10. Curve 86 of FIG. 10 corresponds to the transmission contribution from stage S1, curve 88 corresponds to the transmission contribution from stage S2, curve 90 corresponds to the transmission contribution from stage S3, and curve 84 represents the resulting overall transmission characteristic of filter 68, exhibiting a stop band of bandwidth BW centered at frequency f2 and covering the frequencies in the high band. Out-of-band transmission (e.g., transmission at frequencies near frequency f1) is high (e.g., 80-100% or other suitable values), whereas in-band transmission (i.e., transmission at frequencies near frequency f2) is low (e.g., 0-20% or other suitable value).

Due to the presence of multiple resonant circuit stages (S1, S2, and S3), the overall bandwidth BW of filter 68 can be increased beyond that of a single stage filter. This allows the stop band to be configured to have a bandwidth BW sufficient to cover all frequencies of interest. For example, filter 68 may be configured so that the stop band covers a communications band of interest such as a cellular telephone band or wireless local area network band centered at frequency f2. Bandwidth BW may be, for example, tens of MHz, hundreds of MHz or more (as an example).

Impedance matching circuits such as impedance matching circuit 70 of antenna 40 of FIG. 3 may be used in antenna 40 to ensure that antenna 40 exhibits resonant peaks in desired communications bands (e.g., to adjust the position of the low-band peak at frequency f1). If desired, matching circuit 70 may be implemented using adjustable circuitry. For example, matching circuit 70 may include one or more adjustable circuit components such as switches, varactors, adjustable inductors, variable resistors, or other circuit components having electrical properties that may be adjusted by control circuitry in device 10 in real time. During operation of device 10, control circuitry (see, e.g., storage and processing circuitry 28 of FIG. 2) may adjust the impedance of adjustable matching circuit 70 to tune the frequency response of antenna 40.

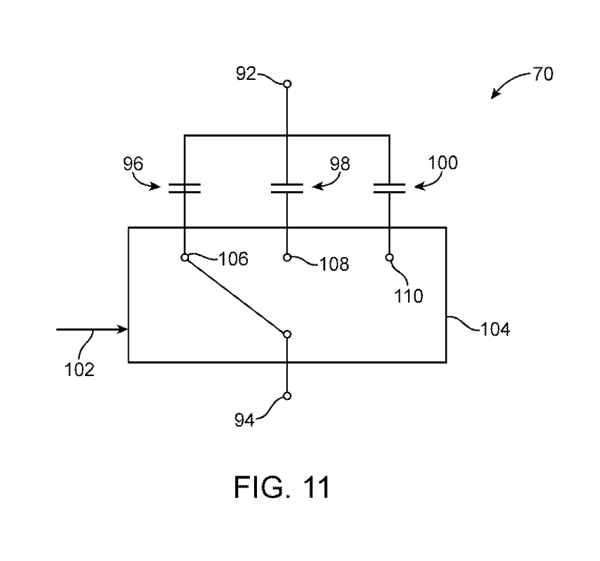

An illustrative adjustable circuit that may be used in implementing matching circuit 70 is shown in FIG. 11. The adjustable circuitry of FIG. 11 that is used in tuning antenna 40 may be coupled between respective portions of antenna resonating element 50, between respective portions of ground 52, or between resonating element 50 and ground 52. As shown in FIG. 3, for example, antenna 40 may have an adjustable antenna tuning circuit such as adjustable circuit 70 that is coupled in series with band-stop filter 68 between a tip portion of antenna resonating element arm 60 in antenna resonating element 50 and antenna ground 52. Adjustable circuit 70 may have a first terminal such as terminal 92 that is coupled to terminal T2 of filter 68 and a second terminal such as terminal 94 that is coupled to antenna ground 52.

In the FIG. 11 example, adjustable circuit 70 is a switch-based adjustable circuit that includes radio-frequency switch 104. Radio-frequency switch 104 may be adjusted using control signals (e.g., control signals from control circuitry in device 10 that are received via control signal path 102). Other types of control mechanisms may be used, if desired.

Switch 104 may be coupled between arm 60 and ground 52 in series with multiple electrical components such as parallel capacitors 96, 98, and 100. Switch 104 may have a terminal such a terminal 94 that is coupled to antenna ground 52. Switch 104 may also have terminals 106, 108, and 110 that are coupled respectively to capacitors 96, 98, and 100 (or if desired, other suitable circuit components such as inductors). Each of capacitors 96, 98, and 100 may have a different respective capacitance value and may therefore each exhibit a different radio-frequency impedance value. When it is desired to couple the capacitance of capacitor 96 between resonating element arm 60 and antenna ground 52, control signals may be provided to switch 104 (e.g., via control path 102) to couple terminal 94 to terminal 106. When it is desired to couple the capacitance of capacitor 98 between resonating element arm 60 and antenna ground 52, control signals may be provided on path 102 to switch 104 to couple terminal 94 to terminal 108. Terminal 94 may be coupled to terminal 110 by switch 104 when it is desired to couple the capacitance of capacitor 100 between resonating element arm 60 and antenna ground 52.

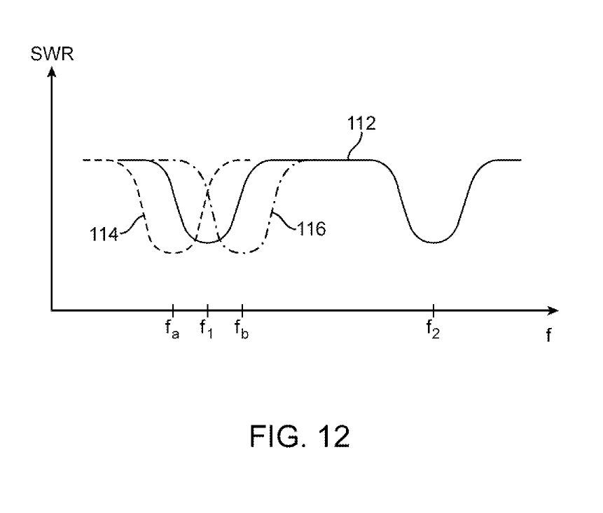

The graph of FIG. 12 shows how an antenna such as antenna 40 of FIG. 3 may be tuned by adjusting matching circuit 70 (e.g., a matching circuit of the type shown in FIG. 11). In FIG. 12, antenna performance (standing wave ratio) has been plotted as a function of frequency f. Curve 112 corresponds to the performance of antenna 40 of FIG. 3 when adjustable circuit 70 of FIG. 11 has been configured so that terminal 94 is connected to terminal 108 (i.e., with capacitance 98 switched into use). When it is desired to tune the low band resonance at frequency f1, control circuitry in device 10 can adjust the state of switch 104. For example, when it is desired to lower the frequency response of the low band resonance so that the center of the low band resonance moves from frequency f1 to frequency fa as shown by curve 114, switch 104 may be configured to connect terminal 94 to terminal 106 to switch capacitor 96 into use. When it is desired to increase the frequency response of the low band resonance so that the center of the low band resonance moves from frequency f1 to frequency fb as shown by curve 116, switch 104 may be configured to connect terminal 94 to terminal 110 to switch capacitor 100 into use.

In this example, adjustment of matching circuit 70 primarily affects the low band performance of antenna 40 at frequencies associated with the communications band at frequency f1 (i.e., high band performance of antenna 40 at frequencies associated with frequency f2 is not significantly affected). If desired, one or more matching circuits such as matching circuit 70 may be used to adjust high band performance and/or performance in one or more additional bands. The tuning of the low band resonance in antenna 40 of FIG. 3 using an adjustable circuit such as adjustable circuit 70 of FIG. 11 is merely illustrative.

The foregoing is merely illustrative of the principles of this invention and various modifications can be made by those skilled in the art without departing from the scope and spirit of the invention.

What is claimed is:

1. An antenna, comprising:
an antenna resonating element;
an antenna ground; and
a multi-stage band-stop filter coupled between the antenna resonating element and the antenna ground.

2. The antenna defined in claim 1 further comprising an impedance matching circuit coupled in series with the multi-stage band-stop filter.

3. The antenna defined in claim 2 wherein the impedance matching circuit comprises an adjustable circuit configured to tune the antenna.

4. The antenna defined in claim 3 wherein the adjustable circuit comprises a radio-frequency switch.

5. The antenna defined in claim 3 wherein the adjustable circuit comprises an adjustable capacitor exhibiting a capacitance that is adjusted using the radio-frequency switch.

6. The antenna defined in claim 3 wherein the antenna resonating element, antenna ground, and multi-stage band-stop filter are configured to resonate in a low communications band and a high communications band and wherein the band-stop filter has a stop band that covers the high communications band.

7. The antenna defined in claim 1 wherein the antenna resonating element, antenna ground, and multi-stage band-stop filter are configured to resonate in a low communications band and a high communications band and wherein the band-stop filter has a stop band that covers the high communications band.

8. The antenna defined in claim 1 wherein the multi-stage band-stop filter comprises inductors and capacitors.

9. The antenna defined in claim 1 wherein the multi-stage band-stop filter comprises a plurality of stages connected in series and wherein each stage of the band-stop filter comprises a resonant circuit with a different respective resonant frequency.

10. The antenna defined in claim 9 wherein each resonant circuit includes a capacitor coupled in parallel with an inductor.

11. The antenna defined in claim 1 wherein the antenna resonating element comprises an inverted-F antenna resonating element having a resonating element arm and wherein the band-stop filter is coupled between the resonating element arm and the antenna ground.

12. An antenna, comprising:
conductive antenna structures configured to transmit and receive radio-frequency antenna signals; and
a band-stop filter that includes a plurality of series-connected resonant circuits, wherein the band-stop filter is coupled between first and second portions of the conductive antenna structures.

13. The antenna defined in claim 12 wherein each of the resonant circuits includes a respective capacitor and inductor.

14. The antenna defined in claim 12 wherein the series-connected resonant circuits comprise:
a first resonant circuit having a first capacitor and a first inductor configured to exhibit a resonance peak at a first frequency; and
a second resonant circuit having a second capacitor and a second inductor configured to exhibit a resonance peak at a second frequency that is different than the first frequency.

15. The antenna defined in claim 12 wherein the band-stop filter has a stop band, wherein the conductive antenna structures are configured to resonate in a first communications band that lies outside of the stop band and are configured to resonate in a second communications band that is covered by the stop band.

16. The antenna defined in claim 15 wherein the series-connected resonant circuits each exhibit a respective resonance with a distinct resonant peak frequency and wherein the resonances overlap to create the stop band.

17. The antenna defined in claim 12 wherein the first portion of the conductive antenna structures comprises a resonating element arm in the resonating element and wherein the second portion of the conductive antenna structures comprises the antenna ground.

18. The antenna defined in claim 17 further comprising an adjustable circuit coupled in series with the band-stop filter between the resonating element arm and the antenna ground.

19. The antenna defined in claim 18 wherein the adjustable circuit comprises a switch-based adjustable capacitor.

20. An antenna, comprising:
an antenna resonating element;
an antenna ground; and
a band-stop filter and an impedance matching circuit coupled in series between the antenna resonating element and the antenna ground.

21. The antenna defined in claim 20 wherein the band-stop filter comprises a plurality of series-connected resonant circuits each with a different respective resonant frequency.

22. The antenna defined in claim 21 wherein the impedance matching circuit comprises an adjustable circuit operable to tune the antenna in response to control signals.

23. The antenna defined in claim 22 wherein the antenna resonating element includes at least one resonating element arm, wherein the band-stop filter and impedance matching circuit are coupled between the resonating element arm and the antenna ground, wherein the band-stop filter is characterized by a stop band, wherein the antenna comprises a feed branch that is coupled between the resonating element arm and the antenna ground, wherein the antenna resonating element, antenna ground, and band-stop filter are configured to operate in at least a first communications band that is outside of the stop band and at least a second communications band that is covered by the stop band.

24. The antenna defined in claim 20 wherein the impedance matching circuit comprises an adjustable circuit configured to tune the antenna in response to control signals.

25. The antenna defined in claim 24 wherein the adjustable circuit includes an adjustable capacitor.

26. The antenna defined in claim 20 wherein the antenna ground comprises a conductive electronic device housing structure.
